(19) United States
(12) Patent Application Publication
(10) Pub. No.: US 2020/0315910 A1
(43) Pub. Date: Oct. 8, 2020

(54) FATIGUE REDUCING DEVICE

(71) Applicant: AISIN SEIKI KABUSHIKI KAISHA, Aichi (JP)

(72) Inventor: Hideaki YAMAGUCHI, Aichi (JP)

(21) Appl. No.: 16/303,803

(22) PCT Filed: Mar. 15, 2017
(86) PCT No.: PCT/JP2017/010508

§ 371 Date: Nov. 21, 2018

(30) Foreign Application Priority Data
May 26, 2016 (JP) 2016-105246

(51) Int. Cl. A61H 23/02; B60N 2/90

(52) U.S. Cl. CPC A61H 23/02; B60N 2/976; A61H 2201/5071; A61H 2203/0431; B60N 2002/981; A61H 2205/081; A61H 2205/062; A61H 2201/5048; A61H 2201/5043

(57) ABSTRACT

A fatigue reducing device according to an embodiment includes, as an example, a determinator that determines whether an occupant sitting on a seat of a vehicle is driving the vehicle, and a controller that controls a vibration device provided in the seat to apply vibration stimulation at a first frequency causing muscular tension to a second muscle serving that is an antagonist muscle to a first muscle that is a massage target in a case where the determinator has determined that the occupant is driving the vehicle.

### TECHNICAL FIELD

The present invention relates to a fatigue reducing device.

### BACKGROUND ART

Conventionally, a technique in which a vibration device is provided in a seat of a vehicle to thereby apply vibration stimulation to a driver of the vehicle has been known. The vibration stimulation can reduce a fatigue feeling of the driver.

### CITATION LIST

### Patent Literature

Patent Document 1: Japanese Patent Application Laid-open No. 2004-284449

### SUMMARY OF INVENTION

### Problem to be Solved by the Invention

Some muscles are however required to be in moderately tensed states when a driver is driving and a fatigue feeling reduction effect can be deteriorated when the vibration stimulation of relaxing muscular tension is applied to such muscles.

It is an object of the present invention to provide a fatigue reducing device capable of reducing a fatigue feeling effectively.

### Means for Solving Problem

A fatigue reducing device according to an embodiment of this invention, for an example, comprises: a determinator that determines whether or not an occupant sitting on a seat of a vehicle is driving the vehicle; and a controller that controls, in a case where the determinator has determined that the occupant is driving the vehicle, a vibration device provided in the seat to apply vibration stimulation at a first frequency causing muscular tension to a second muscle that is an antagonist muscle to a first muscle that is a massage target. Accordingly, muscular tension of the first muscle is therefore moderately relaxed by the muscular tension caused in the second muscle, thereby reducing a fatigue feeling effectively.

With respect to the fatigue reducing device according to an embodiment of this invention, for an example, the controller controls, in the case where the determinator has determined that the occupant is driving the vehicle, to apply the vibration stimulation at the first frequency to the first muscle, and then, apply the vibration stimulation at the first frequency to the second muscle. Blood flow of the first muscle is therefore increased by the muscular tension caused in the first muscle and as a result, persistence of the fatigue feeling reduction effect can be improved.

With respect to the fatigue reducing device according to an embodiment of this invention, for an example, the determinator further determines whether or not the occupant is resting, and the controller controls, in a case where the determinator has determined that the occupant is resting, to apply vibration stimulation at a second frequency causing relaxation of muscular tension to the first muscle. The muscular tension of the first muscle is actively relaxed when the occupant is resting and no muscular tension is required, thereby reducing the fatigue feeling more effectively.

With respect to the fatigue reducing device according to an embodiment of this invention, for an example, the determinator determines, in the case where the determinator has determined that the occupant is driving the vehicle, whether or not the occupant needs to rest based on a frequency of executing massage, and the controller suggests resting to the occupant in a case where the determinator has determined that the occupant needs to rest. An effect by massage in driving can be recovered by causing the occupant to rest, thereby reducing the fatigue feeling more effectively.

With respect to the fatigue reducing device according to an embodiment of this invention, for an example, the controller applies the vibration stimulation at the second frequency to the first muscle and suggests a method of a stretch to the occupant. The occupant can therefore relieve his(her) fatigue feeling also by stretching during resting, for example, thereby reducing the fatigue feeling more effectively.

### BRIEF DESCRIPTION OF DRAWINGS

FIG. 1 is a perspective view illustrating a state in which a part of a vehicle cabin of a vehicle according to the embodiment is seen through;

FIG. 2 is a view illustrating an example of arrangement of vibration devices in the embodiment;

FIG. 3 is a view for explaining an antagonistic action between muscles;

FIG. 4 is another view illustrating the example of the arrangement of the vibration devices in the embodiment;

FIG. 5 is a view illustrating parts to which the respective vibration devices in the embodiment can apply vibration stimulation;

FIG. 6 is a block diagram illustrating an example of a fatigue reducing system in the embodiment;

FIG. 7 is a block diagram illustrating functional components of an electronic control unit (ECU) in the embodiment;

FIG. 8 is a flowchart illustrating an example of operations of a fatigue reducing device in the embodiment;

FIG. 9 is a chart illustrating variation in a shoulder fatigue feeling when vibration stimulation of 50 Hz was applied to trapezius muscles while a subject was driving;

FIG. 10 is a chart illustrating variation in the shoulder fatigue feeling when the vibration stimulation of 100 Hz was applied to latissimus dorsi muscle upper fibers while the subject was driving;

FIG. 11 is a chart illustrating variation in the shoulder fatigue feeling when the vibration stimulation of 100 Hz was applied to the trapezius muscles, and then, the vibration stimulation of 100 Hz was applied to the latissimus dorsi muscle upper fibers while the subject was driving;

FIG. 12 is a chart illustrating variation in a lower back fatigue feeling when the vibration stimulation of 100 Hz was applied to a right latissimus dorsi muscle, and then, the vibration stimulation of 100 Hz was applied to a left latissimus dorsi muscle while the subject was driving;

FIG. 13 is a chart illustrating variation in the shoulder fatigue feeling when the vibration stimulation of 100 Hz was applied to the trapezius muscles while the subject was resting;

FIG. 14 is a chart illustrating variation in the shoulder fatigue feeling when the vibration stimulation of 100 Hz was applied to the latissimus dorsi muscle upper fibers while the subject was resting; and

FIG. 15 is a chart illustrating variation in the shoulder fatigue feeling when the vibration stimulation of 50 Hz was applied to the trapezius muscles while the subject was resting.

### DESCRIPTION OF EMBODIMENTS

Hereinafter, a fatigue reducing device in an exemplary embodiment is mounted on a vehicle 1 for description, as an example.

In the embodiment, the vehicle 1 may be, for example, an automobile (internal combustion engine automobile) using an internal combustion engine (the engine is not illustrated) as a drive source, an automobile (electric automobile, fuel cell automobile, or the like) using an electric motor (the motor is not illustrated) as a drive source, or an automobile (hybrid automobile) using both of them as drive sources. Various transmissions may be mounted on the vehicle 1 and various devices (systems, parts, and the like) necessary for driving the internal combustion engine and/or the electric motor can be mounted thereon. Systems, numbers, layouts, and the like of devices related to driving of wheels 3 of the vehicle 1 can be variously set.

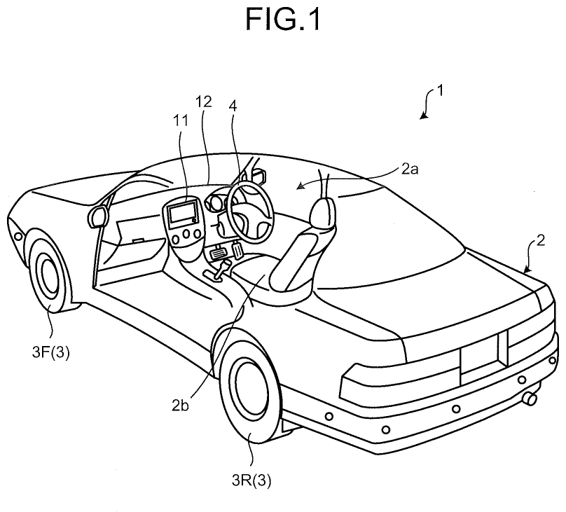

As illustrated in FIG. 1, a vehicle body 2 of the vehicle 1 configures a vehicle cabin 2a in which a driver (not illustrated) gets in. A steering portion 4 and the like are provided in the vehicle cabin 2a in a state of facing a seat 2b of the driver as an occupant. In the embodiment, the steering portion 4 is a steering wheel projecting from a dashboard (instrument panel) 12, as an example.

As illustrated in FIG. 1, in the embodiment, the vehicle 1 is a four-wheel vehicle (four-wheel automobile) and includes two right and left front wheels 3F and two right and left rear wheels 3R, as an example. In the embodiment, all of these four wheels 3 are configured to be capable of being steered (turnable).

A monitor device 11 is provided on a center portion of the dashboard 12 in the vehicle width direction, that is, the right and left direction in the vehicle cabin 2a. A display device 8 and an audio output device 9 are provided on the monitor device 11. The display device 8 is, for example, a liquid crystal display (LCD) or an organic electroluminescent display (OELD). The audio output device 9 is, for example, a speaker. The display device 8 is covered by, for example, a transparent operation input device 10 such as a touch panel. The occupant can view an image displayed on a display screen of the display device 8 through the operation input device 10. The occupant can execute operation input by operating the operation input device 10 by touching, pressing, and moving it with fingers or the like at a position corresponding to the image displayed on the display screen of the display device 8.

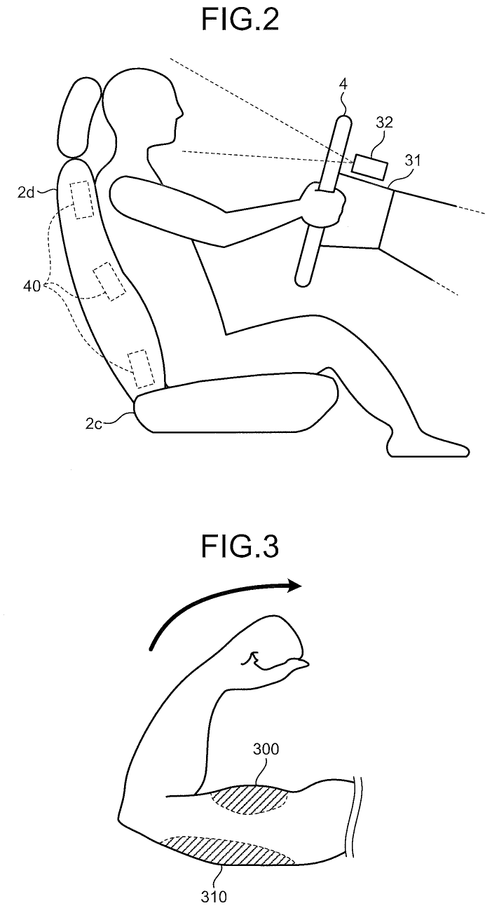

As illustrated in FIG. 2, an image capturing device 32 is installed on a steering wheel column 31. The image capturing device 32 is, for example, a charge coupled device (CCD) camera. The viewing angle and posture of the image capturing device 32 are adjusted such that a driver 200 sitting on a sitting portion 2c of the seat 2b is located at a visual field center thereof. The image capturing device 32 sequentially shoots states of the driver 200 and sequentially outputs pieces of image data of the images provided by shooting.

As illustrated in FIG. 2, a plurality of vibration devices 40 are provided in a backrest portion 2d of the seat 2b. The vibration devices 40 apply vibration stimulation to muscles of the driver 200 to reduce the fatigue feeling that the driver 200 feels. The fatigue feeling includes, for example, stiffness or a feeling of tension. The vibration devices 40 can output vibration of a plurality of different frequencies.

Antagonistic actions between muscles will be described. As illustrated in FIG. 3, when an elbow joint is bent, a biceps brachii muscle 300 is tensed (contracts) and tension of a triceps brachii muscle 310 is relaxed (loosened). When the elbow joint extends, tension of the biceps brachii muscle 300 is relaxed (loosened) and the triceps brachii muscle 310 is tensed (contracts). When a muscle moving a certain portion of a body in one direction forms a pair with a muscle taking opposite movement, like the biceps brachii muscle 300 and the triceps brachii muscle 310 in the elbow joint, one muscle is referred to as an antagonist muscle to the other muscle.

Muscular reaction to the vibration stimulation has dependency on frequency. Application of vibration stimulation at a certain frequency to a muscle tenses the muscle, whereas application of vibration stimulation at another frequency to the muscle relaxes the tension of the muscle. The frequency causing the muscular tension is, for example, 80 to 100 Hz and the frequency causing relaxation of the muscular tension is, for example, 40 to 60 Hz.

In the embodiment, the fatigue reducing device at least applies the vibration stimulation at a frequency causing the muscular tension to the antagonist muscle to a massage target muscle when the driver 200 is driving, in order to enhance a fatigue feeling reduction effect on the massage target muscle. The fatigue reducing device applies the vibration stimulation at a frequency causing the muscular tension to the massage target muscle before applying the vibration stimulation at a frequency causing the muscular tension to the antagonist muscle when the driver 200 is driving, in order to enhance persistence of the fatigue feeling reduction effect. The fatigue reducing device applies the vibration stimulation at a frequency causing the relaxation of the muscular tension to the massage target muscle when the driver 200 is resting.

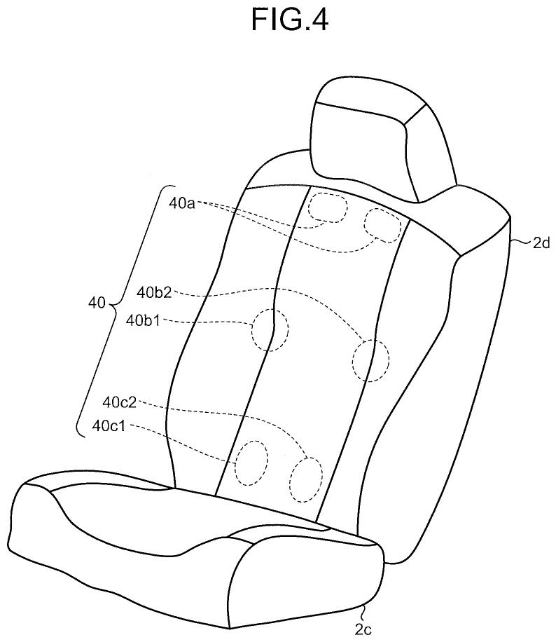

In the embodiment, the shoulder muscles (trapezius muscles) and the lower back muscles (right and left latissimus dorsi muscles) in which a fatigue phenomenon in driving frequently occur are the massage target muscles, as an example. The vibration devices 40 are disposed in the backrest portion 2d of the seat 2b in order to massage the massage target muscles effectively. As illustrated in FIG. 4, six vibration devices 40 are buried in the backrest portion 2d in this example.

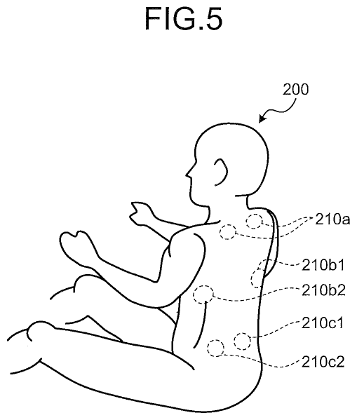

Two vibration devices 40a of the six vibration devices 40 are disposed so as to form a pair of right and left vibration devices in an upper portion of the backrest portion 2d and can apply the vibration stimulation to the right and left trapezius muscles (parts 210a illustrated in FIG. 5) of the driver 200. A vibration device 40b1 and a vibration device 40b2 are disposed at positions corresponding to a part 210b1 and a part 210b2 illustrated in FIG. 5, respectively. The vibration device 40b1 and the vibration device 40b2 can apply the vibration stimulation to, in particular, upper fibers of the latissimus dorsi muscles acting as the antagonist muscles to the trapezius muscles.

A vibration device 40c1 and a vibration device 40c2 are disposed at positions corresponding to a part 210c1 and a part 210c2 illustrated in FIG. 5, respectively. As for the latissimus dorsi muscles, one muscle of the right and left latissimus dorsi muscles acts as the antagonist muscle to the other muscle thereof in a movement of twisting the trunk. The vibration device 40b1 and the vibration device 40c1 can apply the vibration stimulation to the right latissimus dorsi muscle of the driver 200 in corporation. The vibration device 40b2 and the vibration device 40c2 can apply the vibration stimulation to the left latissimus dorsi muscle of the driver 200 in cooperation.

The above-mentioned arrangement of the vibration devices 40 is an example. An arbitrary muscle may be set as the massage target. The vibration devices 40 may be arranged at arbitrary positions corresponding to the massage target muscle in the seat 2b. The vibration devices 40 may not be buried in the seat 2b. The vibration devices 40 may be included in a seat cover covering the seat 2b or a cushion interposed between the seat 2b and the driver 200 for provision.

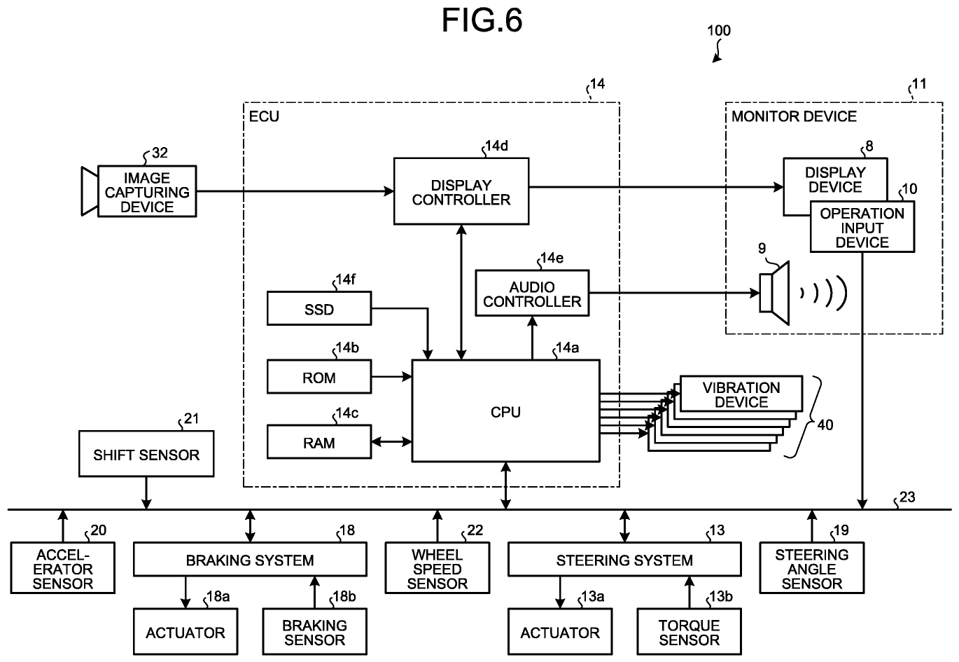

Next, a fatigue reducing system including the fatigue reducing device in the vehicle 1 in the embodiment will be described. FIG. 6 is a block diagram illustrating an example of the configuration of a fatigue reducing system 100 in the embodiment. As illustrated in FIG. 6, in the fatigue reducing system 100, in addition to an ECU 14, the monitor device 11, a steering system 13, and the like, a braking system 18, a steering angle sensor 19, an accelerator sensor 20, a shift sensor 21, a wheel speed sensor 22, and the like are electrically connected to each other via an in-vehicle network 23 as an electric communication line. The in-vehicle network 23 is configured as, for example, a controller area network (CAN). The ECU 14 transmits control signals via the in-vehicle network 23 to thereby control the steering system 13 including an actuator 13a, the braking system 18 including an actuator 18a, and the like. The ECU 14 can receive detection results obtained from a torque sensor 13b, a braking sensor 18b, the steering angle sensor 19, the accelerator sensor 20, the shift sensor 21, the wheel speed sensor 22, and the like, operation signals from the operation input device 10 and the like, and others via the in-vehicle network 23. The ECU 14 is an example of the fatigue reducing device. The ECU 14 can control the vibration devices 40.

The ECU 14 includes, for example, a central processing unit (CPU) 14a, a read only memory (ROM) 14b, a random access memory (RAM) 14c, a display controller 14d, an audio controller 14e, and a solid state drive (SSD) 14f (flash memory). The CPU 14a controls the vehicle 1 overall. The CPU 14a can read a program installed and stored in a non-volatile storage device such as the ROM 14b and execute operation processing in accordance with the program. The RAM 14c temporarily stores therein various pieces of data that are used in operation in the CPU 14a. The display controller 14d executes synthesis of image data that is displayed on the display device 8 and other processing in the operation processing in the ECU 14. The audio controller 14e mainly executes processing of audio data that is output from the audio output device 9 in the operation processing in the ECU 14. The SSD 14f is a non-volatile rewritable storage and can store therein data even when the ECU 14 is powered OFF. The CPU 14a, the ROM 14b, the RAM 14c, and the like can be integrated in a single package. The ECU 14 may use another logical operation processor or another logical circuit such as a digital signal processor (DSP) instead of the CPU 14a. Furthermore, a hard disk drive (HDD) may be provided instead of the SSD 14f, or the SSD 14f and the HDD may be provided separately from the ECU 14.

The configurations, arrangement, electric connection forms, and the like of the above-mentioned various sensors and actuators are examples and can be variously set (changed).

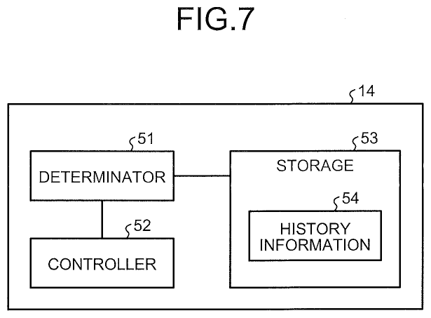

FIG. 7 is a block diagram illustrating functional components of the ECU 14 in the embodiment. As illustrated in FIG. 7, the ECU 14 mainly includes a determinator 51, a controller 52, and a storage 53. The components illustrated in FIG. 7, excluding the storage 53, are implemented by executing the program stored in the ROM 14b by the CPU 14a configured as the ECU 14. These components may be implemented by hardware such as an electronic circuit. The storage 53 is implemented by, for example, the SSD 14f.

The determinator 51 determines whether or not the driver 200 is driving the vehicle 1 and whether or not the driver 200 is resting. Determination criteria of whether or not the driver 200 is driving the vehicle 1 and whether or not the driver 200 is resting are not limited to specific criteria. The determinator 51 determines whether or not the driver 200 is driving the vehicle 1 and whether or not the driver 200 is resting, based on, for example, a signal from a global positioning system (GPS) (not illustrated), the braking system 18, the steering angle sensor 19, the accelerator sensor 20, the shift sensor 21, or the like.

As an example, the determinator 51 determines that the driver 200 is resting when the shift sensor 21 detects a parking position and determines that the driver 200 is driving when the shift sensor 21 does not detect the parking position.

As another example, the determinator 51 determines that the driver 200 is resting when the wheel speed sensor 22 detects a zero value and determines that the driver 200 is driving when the wheel speed sensor 22 detects a value other than the zero value.

The determinator 51 determines massage start timing. A criterion of the massage start timing determined by the determinator 51 is not limited to a specific criterion. The determinator 51 determines the massage start timing based on, for example, input from the driver 200. The input from the driver 200 includes operation input, voice input, and image input.

As an example, the determinator 51 controls the display controller 14d to display, on the display device 8, an input button enabling input indicating the start of the massage to be received. The determinator 51 determines arrival of the massage start timing when the operation input device 10 receives the operation input indicating the start of the massage. A method for receiving the operation input is not limited to the receiving method through the operation input device 10. A hardware button enabling input indicating the start of the massage may be provided on the steering portion 4 or the instrument panel 12. An input button may be configured such that the driver can select whether the shoulders are to be massaged or the lower back is to be massaged.

As another example, the determinator 51 determines the massage start timing based on voice input from a microphone (not illustrated). When the determinator 51 receives input of voice, it analyzes the input voice. The determinator 51 determines whether the input voice corresponds to an instruction to start the massage and determines arrival of the massage start timing when it determines that the input voice corresponds to the instruction to start the massage.

As still another example, the determinator 51 determines the massage start timing based on an image of the driver 200 captured by the image capturing device 32. The determinator 51 stores expressions or gestures in advance, analyzes the image to determine whether or not the driver 200 makes any of the previously stored expressions and gestures. The determinator 51 determines arrival of the massage start timing when the driver 200 makes any of the previously stored expressions and gestures. Alternatively, the determinator 51 may extract an expression or gesture of the driver 200 from the image and analyze whether the extracted expression or gesture corresponds to the instruction to start the massage.

The determinator 51 may determine the massage start timing based on another information.

As an example, the determinator 51 determines the massage start timing based on elapsed time. The determinator 51 measures driving continuation time by a timer (not illustrated), for example. The driving continuation time is time during which the driver 200 continues to drive successively, for example. The determinator 51 determines arrival of the massage start timing when the driving continuation time reaches a predetermined threshold. The determinator 51 may determine the massage start timing periodically by resetting the timer after the arrival of the massage start timing. The threshold for determination of the massage start timing may be varied. The threshold for determination of the massage start timing may be automatically changed depending on conditions such as the speed of the vehicle 1 or a frequency of executing the massage. The driver 200 may set the threshold for determination of the massage start timing in advance. The fatigue feeling can be prevented from increasing by starting the massage in accordance with the elapsed time.

The determinator 51 determines whether the shoulders (trapezius muscles) are to be massaged or the lower back (latissimus dorsi muscles) is to be massaged when the driver 200 is driving the vehicle 1. A determination criterion whether the shoulders are to be massaged or the lower back is to be massaged is not limited to a specific criterion. As an example, the determinator 51 determines whether the shoulders are to be massaged or the lower back is to be massaged based on operation input in the same manner as the determination criterion of the massage start timing. The driver 200 may set whether the shoulders are to be massaged or the lower back is to be massaged in advance.

When the determinator 51 determines that the shoulders are to be massaged, the controller 52 controls the corresponding vibration devices 40 to apply the vibration stimulation at a frequency causing the muscular tension to the trapezius muscles, and then, apply the vibration stimulation at a frequency causing the muscular tension to the latissimus dorsi muscles as the antagonist muscles to the trapezius muscles. As an example, the controller 52 controls the vibration devices 40a to output vibration of 100 Hz, and shortly thereafter, controls the vibration devices 40b1 and 40b2 to output vibration of 100 Hz. An output period of each vibration stimulation can be arbitrarily set. As an example, the output period of each vibration stimulation is 30 seconds. When the vibration stimulation is applied to the latissimus dorsi muscles, the controller 52 controls the vibration devices 40b1 and 40b2 and the vibration devices 40c1 and 40c2 to output the vibration stimulation.

When the determinator 51 determines that the lower back is to be massaged, the controller 52 controls the corresponding vibration devices 40 to apply the vibration stimulation at a frequency causing the muscular tension to one of the right and left latissimus dorsi muscles, and then, apply the vibration stimulation at a frequency causing the muscular tension to the other one of the right and left latissimus dorsi muscles. As an example, the controller 52 controls the vibration devices 40b1 and 40c1 to output vibration of 100 Hz, and shortly thereafter, controls the vibration devices 40b2 and 40c2 to output vibration of 100 Hz. An output period of each vibration stimulation can be arbitrarily set. As an example, the output period of each vibration stimulation is 30 seconds. The controller 52 changes the order of the application of the vibration stimulation for each execution of the massage.

When the determinator 51 determines that the driver 200 is driving the vehicle 1, the determinator 51 determines whether or not the driver 200 needs to rest based on the frequency of executing the massage. To be specific, every time the determinator 51 determines the arrival of the massage start timing when the driver 200 is driving the vehicle 1, the determinator 51 records, in the storage 53, the arrival of the massage start timing as history information 54, for example. The determinator 51 calculates the frequency of executing the massage based on the history information 54 and compares the calculated frequency of executing the massage and a predetermined threshold related to the frequency of executing the massage. When the calculated frequency of executing the massage exceeds the threshold, the determinator 51 determines that the driver 200 needs to rest. The frequency of executing is, for example, the number of times of execution within a most recent predetermined period of time.

When the determinator 51 determines that the driver 200 needs to rest, the controller 52 suggests resting to the driver 200. A suggestion manner is not limited to a specific manner. For example, an image prompting the driver to rest may be displayed on the display device 8. Alternatively, sound prompting the driver to rest may be output from the audio output device 9.

The determinator 51 determines whether both of the shoulders (trapezius muscles) and the lower back (latissimus dorsi muscles) are to be massaged, only the shoulders (trapezius muscles) are to be massaged, or only the lower back (latissimus dorsi muscles) is to be massaged when the driver 200 is resting. A determination criterion whether both of the shoulders and the lower back are to be massaged, the shoulders are to be massaged, or the lower back is to be massaged is not limited to a specific criterion. As an example, the determinator 51 determines whether both of the shoulders and the lower back are to be massaged, the shoulders are to be massaged, or the lower back is to be massaged based on operation input in the same manner as the determination criterion of the massage start timing. The driver 200 may set, in advance, whether both of the shoulders and the lower back are to be massaged, the shoulders are to be massaged, or the lower back is to be massaged when the driver 200 is resting.

When the determinator 51 determines that the driver 200 is resting and the shoulders (trapezius muscles) and the lower back (latissimus dorsi muscles) are to be massaged, the determinator 51 determines which of the shoulders or the lower back is intensively massaged based on the execution frequencies of the massage for the respective parts. For example, when the shoulders or the lower back is massaged when the driver 200 is driving, the determinator 51 records the execution in the history information 54. The determinator 51 selects any of the shoulders and the lower back that have(has) been massaged more frequently in the history information 54 as a target to be intensively massaged. A determination criterion which of the shoulders or the lower back is to be intensively massaged is not limited to the above-mentioned determination criterion.

When the determinator 51 determines that the driver 200 is resting, the controller 52 controls the respective vibration devices 40 to apply the vibration stimulation at a frequency causing the relaxation of the muscular tension to the massage target muscle at the part selected by the determinator 51. To be specific, when the determinator 51 selects the shoulders, the controller 52 controls the vibration devices 40a to output vibration of 50 Hz. When the determinator 51 selects the lower back, the controller 52 controls the vibration device 40b1, the vibration device 40b2, the vibration device 40c1, and the vibration device 40c2 to output vibration of 50 Hz. An output period of the vibration stimulation may be arbitrarily set even when it is determined that the driver 200 is resting.

When the determinator 51 determines that the driver 200 is resting, the controller 52 suggests a method of a stretch to the driver 200. A suggestion manner is not limited to a specific manner. For example, an image for explaining the method of the stretch may be displayed on the display device 8. Alternatively, sound for explaining the method of the stretch may be output from the audio output device 9. As an example, the controller 52 changes the method of the stretch that is suggested to the driver 200 for each part selected by the determinator 51.

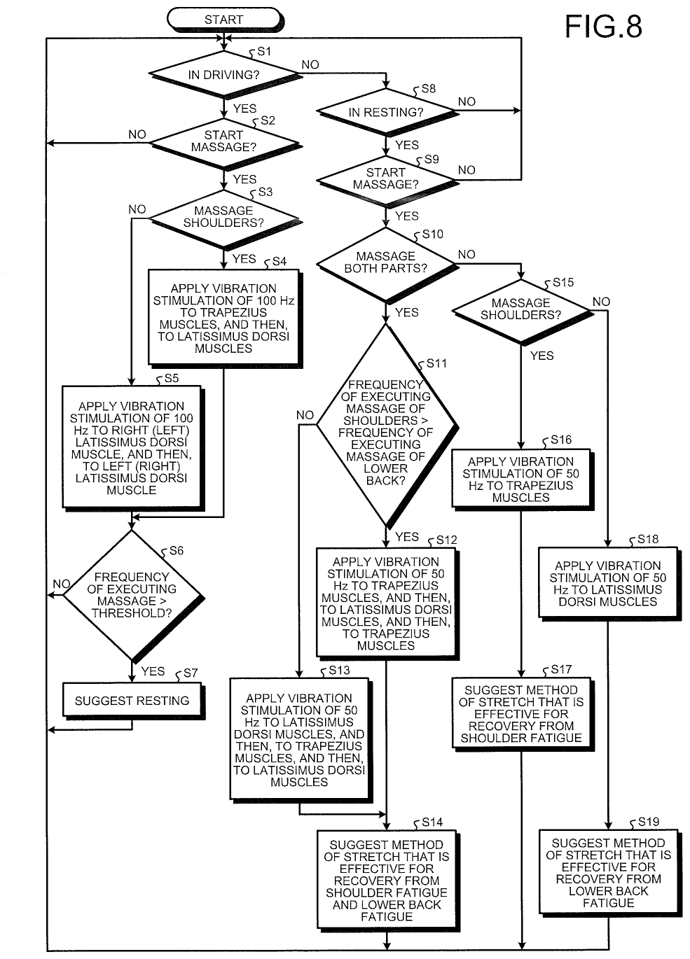

Next, operations of the fatigue reducing device in the embodiment configured as described above will be described. FIG. 8 is a flowchart illustrating an example of the operations of the fatigue reducing device in the embodiment.

First, the determinator 51 determines whether or not the driver 200 is driving (S1). When the determinator 51 has determined that the driver 200 is driving (Yes at S1), the determinator 51 determines whether or not the massage start timing has come (S2). When the determinator 51 has determined that the massage start timing has not come (No at S2), the process returns to S1. When the determinator 51 has determined that the massage start timing has come (Yes at S2), the determinator 51 determines whether or not the shoulders are to be massaged (S3).

When the determinator 51 has determined that the shoulders are to be massaged (Yes at S3), the controller 52 controls to apply the vibration stimulation of 100 Hz to the trapezius muscles, and then, apply the vibration stimulation of 100 Hz to the latissimus dorsi muscles (S4). To be specific, the controller 52 controls the two vibration devices 40a to output the vibration stimulation of 100 Hz, and then, controls the vibration device 40b1 and the vibration device 40b2 to output the vibration stimulation of 100 Hz. When the controller 52 controls the vibration device 40b1 and the vibration device 40b2 to output the vibration stimulation, it may also control the vibration device 40c1 and the vibration device 40c2 to output the vibration stimulation and thereby apply the vibration stimulation to not only the latissimus dorsi muscle upper fibers but also the entire latissimus dorsi muscles.

When the determinator 51 has determined that the shoulders are not massaged (No at S3), the controller 52 controls to apply the vibration stimulation of 100 Hz to the right latissimus dorsi muscle, and then, apply the vibration stimulation of 100 Hz to the left latissimus dorsi muscle (S5). To be specific, the controller 52 controls the vibration device 40b1 and the vibration device 40c1 to output the vibration stimulation of 100 Hz, and then, controls the vibration device 40b2 and the vibration device 40c2 to output the vibration stimulation of 100 Hz. As for the right and left latissimus dorsi muscles, the order of application of the vibration stimulation is changed for each execution of the processing at S5.

After the processing at S4 or the processing at S5, the controller 52 determines whether the frequency of executing the massage is higher than the threshold related to the frequency of executing the massage (S6). When the controller 52 has determined that the frequency of executing the massage is higher than the threshold related to the frequency of executing the massage (Yes at S6), the controller 52 suggests resting to the driver 200 (S7), and the process returns to S1. When the controller 52 has determined that the frequency of executing the massage is not higher than the threshold related to the frequency of executing the massage (No at S6), the process returns to S1.

When the determinator 51 has determined that the driver 200 is not driving (No at S1), the determinator 51 determines whether or not the driver 200 is resting (S8). When the determinator 51 has determined that the driver 200 is not resting (No at S8), the process returns to S1.

When the determinator 51 has determined that the driver 200 is resting (Yes at S8), the determinator 51 determines whether the massage start timing has come (S9). When the determinator 51 has determined that the massage start timing has not come (No at S9), the process returns to S1. When the determinator 51 has determined that the massage start timing has come (Yes at S9), the determinator 51 determines whether the shoulders and the lower back are to be massaged (S10).

When it has been determined that the shoulders and the lower back are to be massaged (Yes at S10), the determinator 51 determines whether the frequency of executing the massage of the shoulders is higher than the frequency of executing the massage of the lower back (S11).

When the determinator 51 has determined that the frequency of executing the massage of the shoulders is higher than the frequency of executing the massage of the lower back (Yes at S11), the controller 52 controls to apply vibration stimulation of 50 Hz to the trapezius muscles, and then, apply the vibration stimulation of 50 Hz to the latissimus dorsi muscles, and then, apply the vibration stimulation of 50 Hz to the trapezius muscles (S12). To be specific, the controller 52 controls the two vibration devices 40a to output the vibration stimulation of 50 Hz, and then, controls the vibration device 40b1, the vibration device 40b2, the vibration device 40c1, and the vibration device 40c2 to output the vibration stimulation of 50 Hz, and then, controls the two vibration devices 40a to output the vibration stimulation of 50 Hz again.

When the determinator 51 has determined that the frequency of executing the massage of the shoulders is not higher than the frequency of executing the massage of the lower back (No at S11), the controller 52 controls to apply the vibration stimulation of 50 Hz to the latissimus dorsi muscles, and then, apply the vibration stimulation of 50 Hz to the trapezius muscles, and then, apply the vibration stimulation of 50 Hz to the latissimus dorsi muscles (S13). To be specific, the controller 52 controls the vibration device 40b1, the vibration device 40b2, the vibration device 40c1, and the vibration device 40c2 to output the vibration stimulation of 50 Hz, and then, controls the two vibration devices 40a to output the vibration stimulation of 50 Hz, and then, controls the vibration device 40b1, the vibration device 40b2, the vibration device 40c1, and the vibration device 40c2 to output the vibration stimulation of 50 Hz again.

After the processing at S12 or the processing at S13, the controller 52 suggests a method of a stretch that is effective for recovery from shoulder fatigue and lower back fatigue to the driver 200 (S14), and the process returns to S1.

When the determinator 51 has determined that the shoulders and the lower back are not massaged (No at S10), the determinator 51 determines whether the shoulders are to be massaged (S15). When the determinator 51 has determined that the shoulders are to be massaged (Yes at S15), the controller 52 controls to apply the vibration stimulation of 50 Hz to the trapezius muscles (S16). To be specific, the controller 52 controls the two vibration devices 40a to output the vibration stimulation of 50 Hz. Then, the controller 52 suggests a method of a stretch that is effective for recovery from the shoulder fatigue to the driver 200 (S17), and the process returns to S1.

When the determinator 51 has determined that the shoulders are not massaged (No at S15), the controller 52 controls to apply the vibration stimulation of 50 Hz to the latissimus dorsi muscles (S18). To be specific, the controller 52 controls the vibration device 40b1, the vibration device 40b2, the vibration device 40c1, and the vibration device 40c2 to output the vibration stimulation of 50 Hz. Then, the controller 52 suggests a method of a stretch that is effective for recovery from the lower back fatigue to the driver 200 (S19), and the process returns to S1.

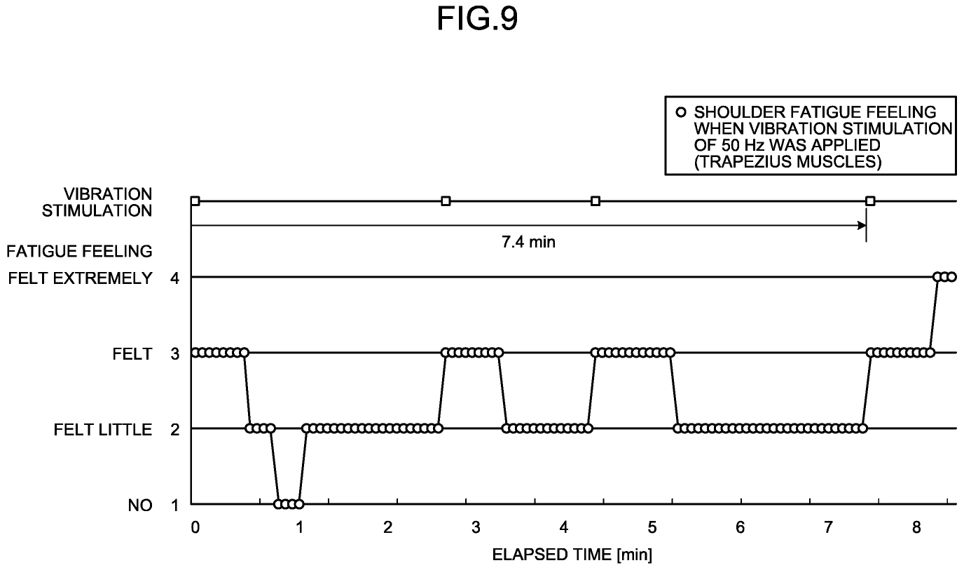

The inventors of the invention of the present application observed transition of the fatigue feeling that a subject felt, obtained by applying vibration stimulation at various frequencies to muscles of the subject during driving. FIGS. 9 to 12 are charts illustrating experiment results thereof.

FIG. 9 is a chart illustrating variation in the shoulder fatigue feeling when the vibration stimulation of 50 Hz was applied to the trapezius muscles (the parts 210a illustrated in FIG. 5) while the subject was driving. The longitudinal axis indicates a score of the fatigue feeling and an uppermost stage indicates an application timing of the vibration stimulation. The fatigue feeling that the subject felt was digitized as follows. That is, the score of the fatigue feeling is 1 when the subject felt no fatigue feeling, the score of the fatigue feeling is 2 when the subject felt a little fatigue feeling, the score of the fatigue feeling is 3 when the subject felt the fatigue feeling, and the score of the fatigue feeling is 4 when the subject felt an extreme fatigue feeling. The transverse axis indicates time. From the experiment result under these conditions, an average value of the score of the fatigue feeling was 2.3. When the vibration stimulation of 50 Hz was applied to the trapezius muscles, the fatigue feeling was temporarily alleviated but the effect did not last long.

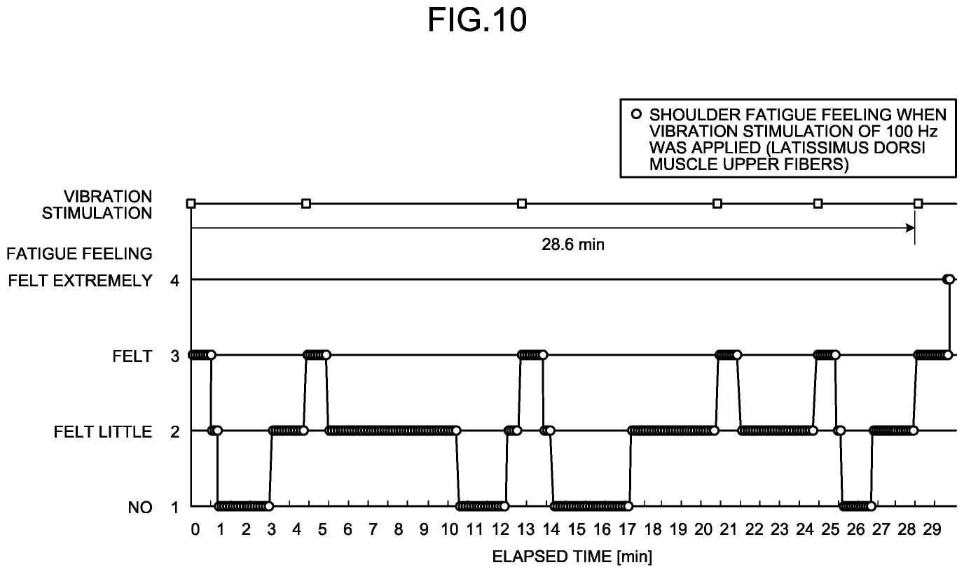

FIG. 10 is a chart illustrating variation in the shoulder fatigue feeling when the vibration stimulation of 100 Hz was applied to the latissimus dorsi muscle upper fibers (the part 210b1 and the part 210b2) while the subject was driving. In this case, an average value of the score of the fatigue feeling was 1.9. When the vibration stimulation of 100 Hz was applied to the latissimus dorsi muscle upper fibers, the fatigue feeling reduction effect was improved and persistence of the fatigue feeling reduction effect was enhanced in comparison with the case in which the vibration stimulation of 50 Hz was applied directly to the trapezius muscles as the massage target muscles.

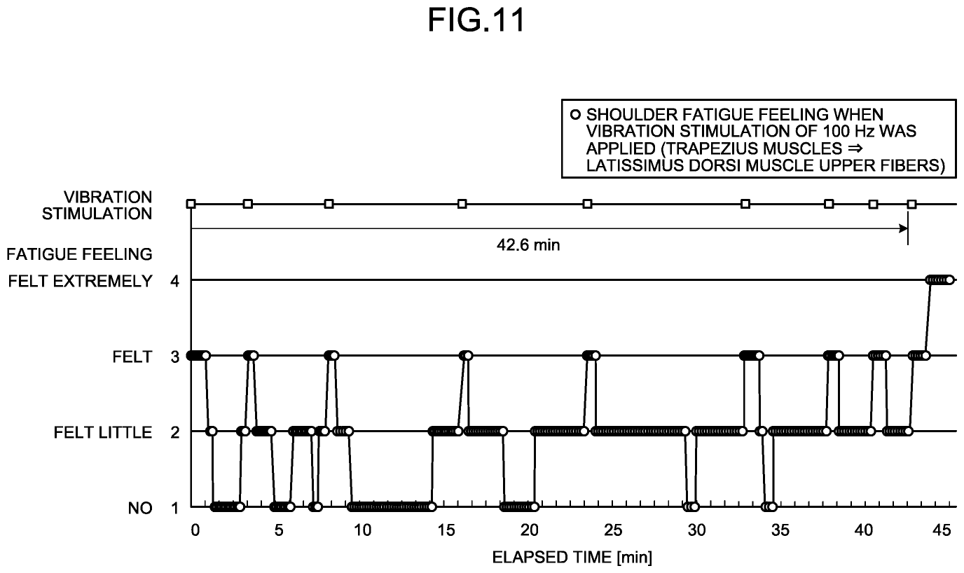

FIG. 11 is a chart illustrating variation in the shoulder fatigue feeling when the vibration stimulation of 100 Hz was applied to the trapezius muscles (the parts 210a), and immediately after that, the vibration stimulation of 100 Hz was applied to the latissimus dorsi muscle upper fibers (the part 210b1 and the part 210b2) while the subject was driving. These conditions are the same as those in the processing at S4 in the embodiment. In this case, an average value of the score of the fatigue feeling was 1.9 and the fatigue feeling reduction effect was kept at a high level. The persistence of the fatigue feeling reduction effect was further enhanced in comparison with the case in which the vibration stimulation of 100 Hz was applied to the latissimus dorsi muscle upper fibers only.

The trapezius muscles are required to be in the moderately tensed states when the subject is driving. When the tension of the trapezius muscles is forcibly relaxed by applying the vibration stimulation at a frequency causing the relaxation of the muscular tension to the trapezius muscles, the trapezius muscles need to be returned to be in the muscular tensed states after the vibration stimulation and load is imposed on the trapezius muscles.

In contrast, when the vibration stimulation at a frequency causing the muscular tension is applied to the latissimus dorsi muscles as the antagonist muscles, the muscular tension of the trapezius muscles is relaxed by the antagonistic action. The muscular tension is relaxed as a result of adjustment controlled in a living body and therefore excessive relaxation of the tension of the trapezius muscles hardly occurs. Accordingly, the load is less imposed on the trapezius muscles. That is, when the vibration stimulation at a frequency causing the muscular tension is applied to the latissimus dorsi muscles, the fatigue feeling reduction effect of the trapezius muscles is higher than that in the case in which the vibration stimulation at a frequency causing the relaxation of the muscular tension is applied to the trapezius muscles.

Further, when the vibration stimulation at a frequency causing the muscular tension is applied to the trapezius muscles before the vibration stimulation at a frequency causing the muscular tension is applied to the latissimus dorsi muscles, the muscular tension of the trapezius muscles is temporarily increased before the muscular tension of the trapezius muscles is relaxed. Blood flow distribution to the trapezius muscles is thereby increased. As a result, in the trapezius muscles, the persistence of the fatigue feeling reduction effect of the trapezius muscles is further enhanced by the blood flow increase effect and the muscular tension relaxation effect by the antagonistic action.

Thus, application of the vibration stimulation at a frequency causing the muscular tension to the antagonist muscle to the massage target muscle exerts a higher fatigue feeling reduction effect than application of the vibration stimulation at a frequency causing the relaxation of the muscular tension directly to the massage target muscle. Further, when the vibration stimulation at a frequency causing the muscular tension is applied to the massage target muscle, and then, the vibration stimulation at a frequency causing the muscular tension is applied to the antagonist muscle to the massage target muscle, the persistence of the fatigue feeling reduction effect is further enhanced.

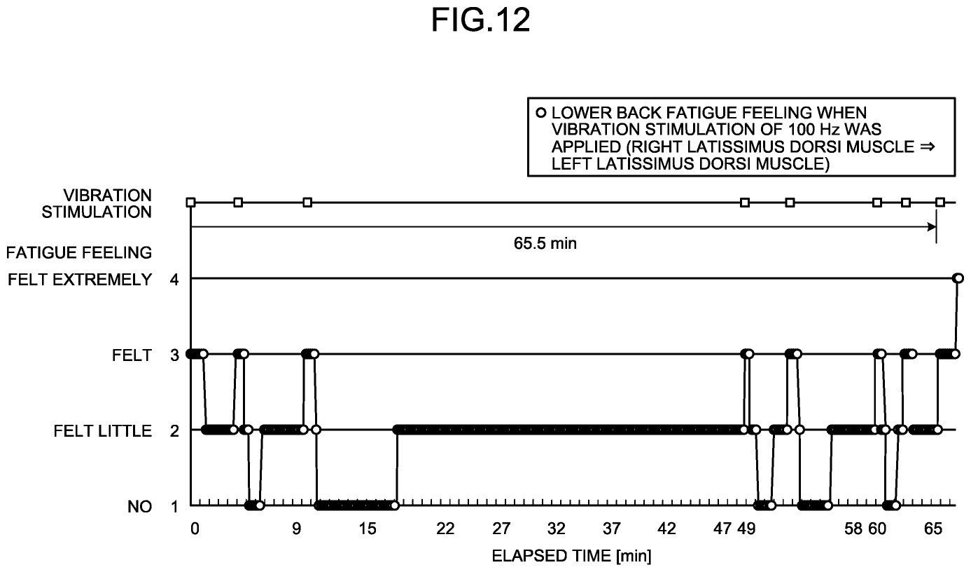

FIG. 12 is a chart illustrating variation in the lower back fatigue feeling when the vibration stimulation of 100 Hz was applied to the right latissimus dorsi muscle (the part 210b1 and the part 210c1), and then, the vibration stimulation of 100 Hz was applied to the left latissimus dorsi muscle (the part 210b2 and the part 210c2) while the subject was driving. These conditions are the same as those in the processing at S5 in the embodiment. Thus, as for the lower back fatigue feeling as well, alternate application of the vibration stimulation at a frequency causing the muscular tension to the right and left latissimus dorsi muscles with the antagonistic relation can increase the fatigue feeling reduction effect and enhance the persistence of the fatigue feeling reduction effect by the blood flow increase effect and the tension relaxation effect by the antagonistic action.

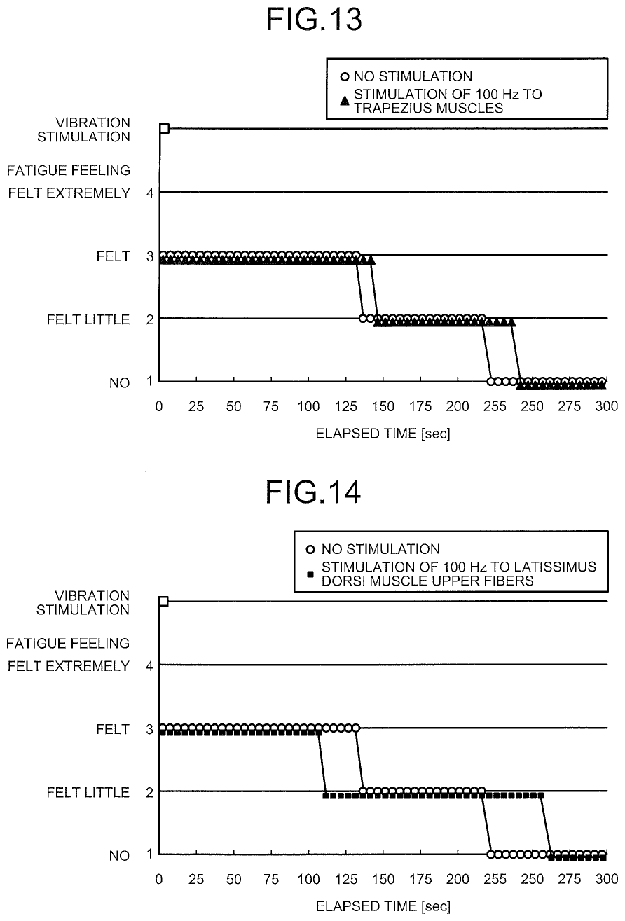

The inventors of the invention of the present application further observed transition of the fatigue feeling that the subject felt, obtained by applying vibration stimulation at various frequencies to muscles when the subject rested quiet in a sitting posture (that is, the subject who was resting) felt the fatigue feeling. FIGS. 13 to 15 are charts illustrating experiment results thereof. The respective drawings illustrate variations in the fatigue feeling when no vibration stimulation was applied as comparison.

FIG. 13 is a chart illustrating variation in the shoulder fatigue feeling when the vibration stimulation of 100 Hz was applied to the trapezius muscles (the parts 210a) while the subject was resting. The score of the fatigue feeling in an initial state was 3. As illustrated in the drawing, there was little difference in a fatigue feeling relieving effect between the case in which the vibration stimulation of 100 Hz was applied to the trapezius muscles and the case in which no vibration stimulation was applied.

FIG. 14 is a chart illustrating variation in the shoulder fatigue feeling when the vibration stimulation of 100 Hz was applied to the latissimus dorsi muscle upper fibers (the part 210b1 and the part 210b2) while the subject was resting. When the vibration stimulation of 100 Hz was applied to the latissimus dorsi muscle upper fibers, time taken to relieve the fatigue feeling was slightly shortened in comparison with the case in which the vibration stimulation of 100 Hz was applied to the trapezius muscles.

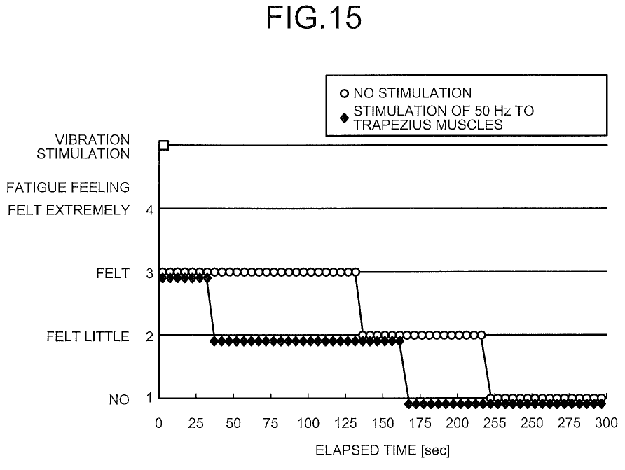

FIG. 15 is a chart illustrating variation in the shoulder fatigue feeling when the vibration stimulation of 50 Hz was applied to the trapezius muscles (the parts 210a) while the subject was resting. These conditions are the same as those in the processing at S16 in the embodiment. When the vibration stimulation of 50 Hz was applied to the trapezius muscles, time taken to relieve the fatigue feeling was largely shortened in comparison with the case in which the vibration stimulation of 100 Hz was applied to the trapezius muscles and the case in which the vibration stimulation of 100 Hz was applied to the latissimus dorsi muscle upper fibers.

Thus, when the driver 200 is resting, the fatigue feeling can be reduced more effectively by applying the vibration stimulation at a frequency causing the relaxation of the muscular tension directly to the massage target muscle. When the driver 200 is resting, the muscles are not required to be tensed and the muscular tension can therefore be actively relaxed by contrast to the case in which the driver 200 is driving.

As describe above, in the embodiment, the fatigue reducing device at least applies the vibration stimulation at a frequency causing the muscular tension to the antagonist muscle to the massage target muscle when the driver 200 is driving the vehicle 1. When the driver 200 is driving the vehicle 1, the fatigue feeling reduction effect is thereby improved in comparison with the case in which the vibration stimulation at a frequency causing the relaxation of the muscular tension is applied to the massage target muscle. That is, the fatigue feeling can be reduced effectively.

In the embodiment, the fatigue reducing device applies the vibration stimulation at a frequency causing the muscular tension to the massage target muscle before applying the vibration stimulation at a frequency causing the muscular tension to the antagonist muscle. When the driver 200 is driving the vehicle 1, the blood flow increase effect and the tension relaxation effect caused by the antagonistic action can thereby be provided for the massage target muscle, thereby further enhancing the persistence of the fatigue feeling reduction effect.

The fatigue reducing device may not apply the vibration stimulation at a frequency causing the muscular tension to the massage target muscle before applying the vibration stimulation at a frequency causing the muscular tension to the antagonist muscle to the massage target muscle. Even in this case, the fatigue feeling reduction effect can be improved as indicated in the experiment result in FIG. 10.

In the embodiment, the fatigue reducing device applies the vibration stimulation at a frequency causing the relaxation of the muscular tension to the massage target muscle when the driver 200 is resting. When the driver 200 is resting, the muscular tension of the massage target muscle is thereby actively relaxed, so that the fatigue feeling can be reduced effectively. The vibration stimulation at an appropriate frequency is applied to the appropriate part in accordance with whether the driver 200 is driving the vehicle 1 or is resting. The fatigue feeling can therefore be reduced effectively in comparison with the case in which the vibration stimulation at the same frequency is applied to the same part regardless of whether the driver 200 is driving the vehicle 1 or is resting.

In the embodiment, the fatigue reducing device determines whether or not the driver 200 needs to rest based on the frequency of executing the massage when the driver 200 is driving the vehicle 1. When the fatigue reducing device determines that the driver 200 needs to rest, it suggests resting to the driver 200. Frequent massage when the driver 200 is driving weakens the fatigue feeling reduction effect by massage. Suggestion of resting to cause the driver 200 to rest before the fatigue feeling reduction effect by massage is not exerted can recover the fatigue feeling reduction effect by massage, thereby reducing the fatigue feeling more effectively than the case in which the driver 200 continuously drives the vehicle 1 for long time.

In the embodiment, the fatigue reducing device suggests a method of a stretch to the driver 200 when the driver 200 is resting. The driver 200 performs stretching according to the suggested stretch, thereby further reducing the fatigue feeling.

The fatigue reducing device may adjust the timing or contents for prompting the driver to rest in accordance with the frequency of executing the massage on the shoulders and the frequency of executing the massage on the lower back.

The fatigue reducing device may change a method of a stretch to be suggested in accordance with the frequency of executing the massage. As an example, the fatigue reducing device suggests a method of a harder stretch when the frequency of executing the massage is high and suggests a method of a softer stretch when the frequency of executing the massage is low.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### EXPLANATIONS OF LETTERS OR NUMERALS

1 VEHICLE
2 VEHICLE BODY
2a VEHICLE CABIN
2b SEAT
2c SITTING PORTION
2d BACKREST PORTION
3 WHEEL
3F FRONT WHEEL
3R REAR WHEEL
4 STEERING PORTION
8 DISPLAY DEVICE
9 AUDIO OUTPUT DEVICE
10 OPERATION INPUT DEVICE
11 MONITOR DEVICE
12 DASHBOARD
13 STEERING SYSTEM
13a ACTUATOR
13b TORQUE SENSOR
14 ECU
14a CPU
14b ROM
14c RAM
14d DISPLAY CONTROLLER
14e AUDIO CONTROLLER
14f SSD
18 BRAKING SYSTEM
18a ACTUATOR
18b BRAKING SENSOR
19 STEERING ANGLE SENSOR
20 ACCELERATOR SENSOR
21 SHIFT SENSOR
22 WHEEL SPEED SENSOR
23 IN-VEHICLE NETWORK
31 STEERING WHEEL COLUMN
32 IMAGE CAPTURING DEVICE
40, 40a, 40b1, 40b2, 40c1, 40c2 VIBRATION DEVICE
51 DETERMINATOR
52 CONTROLLER
53 STORAGE
54 HISTORY INFORMATION
100 FATIGUE REDUCING SYSTEM
200 DRIVER
210a, 210b1, 210b2, 210c1, 210c2 PART
300 BICEPS BRACHII MUSCLE
310 TRICEPS BRACHII MUSCLE

1. A fatigue reducing device comprising:
a determinator that determines whether or not an occupant sitting on a seat of a vehicle is driving the vehicle; and
a controller that controls, in a case where the determinator has determined that the occupant is driving the vehicle, a vibration device provided in the seat to apply vibration stimulation at a first frequency causing muscular tension to a first muscle that is an antagonist muscle to a first second muscle that is a massage target.

2. The fatigue reducing device according to claim 1, wherein the controller controls, in the case where the determinator has determined that the occupant is driving the vehicle, to apply the vibration stimulation at the first frequency to the second muscle, and then, apply the vibration stimulation at the first frequency to the first muscle.

3. The fatigue reducing device according to claim 1, wherein
the determinator further determines whether or not the occupant is resting, and
the controller controls, in a case where the determinator has determined that the occupant is resting, to apply vibration stimulation at a second frequency causing relaxation of muscular tension to the second muscle.

4. The fatigue reducing device according to claim 1, wherein
the determinator determines, in the case where the determinator has determined that the occupant is driving the vehicle, whether or not the occupant needs to rest based on a frequency of executing massage, and
the controller suggests resting to the occupant in a case where the determinator has determined that the occupant needs to rest.

5. The fatigue reducing device according to claim 3, wherein the controller applies the vibration stimulation at the second frequency to the second muscle and suggests a method of a stretch to the occupant.
